(19) United States
(12) Patent Application Publication
(10) Pub. No.: US 2025/0222678 A1
(43) Pub. Date: Jul. 10, 2025

(54) FUNCTIONAL FILM AS WELL AS PREPARATION METHOD AND APPLICATION THEREOF

(71) Applicant: Shenzhen Joaboa Technology Co., Ltd., Shenzhen (CN)

(72) Inventors: Jiheng Jiang, Shenzhen (CN); Jiaan Lu, Shenzhen (CN); Jingyi Zhou, Shenzhen (CN)

(21) Appl. No.: 19/091,874

(22) Filed: Mar. 27, 2025

Related U.S. Application Data
(63) Continuation-in-part of application No. PCT/CN2023/121515, filed on Sep. 26, 2023.

(30) Foreign Application Priority Data
Sep. 29, 2022 (CN) 202211200132.X

(51) Int. Cl. B32B 11/04

(52) U.S. Cl. CPC B32B 11/046; B32B 2307/718; B32B 2307/7265; B32B 2419/00

(57) ABSTRACT

Disclosed are a functional film for enhancing the bonding strength of a polymeric film and asphalt size and a preparation method thereof. The functional film includes a polymeric film layer and a performance improvement layer, the performance improvement layer includes a viscous layer and a passivation layer, and a layer number of the viscous layer and a layer number of the passivation layer are not 0 simultaneously. By arranging the performance improvement layer, the low-temperature peeling strength of the polymeric film layer and an asphalt size layer is effectively improved by utilizing the bonding strength of the performance improvement layer and the polymeric film layer and the good bonding force of the performance improvement layer and the asphalt size layer, and the problem that the bonding performance of an existing polymeric film and an asphalt size layer is obviously reduced in a low-temperature environment is solved.

### CROSS-REFERENCE TO RELATED APPLICATIONS

The present application is a continuation-in-part application of PCT application No. PCT/CN2023/121515 filed on Sep. 26, 2023, which claims the benefit of Chinese Patent Application No. 202211200132.X filed on Sep. 29, 2022. The contents of all of the aforementioned applications are incorporated by reference herein in their entirety.

### FIELD OF TECHNOLOGY

The present disclosure belongs to the technical field of polymers, specifically relates to a functional film for enhancing the bonding strength of a polymeric film and asphalt size, and also relates to a preparation method and application of the functional film.

### BACKGROUND

A polymeric film can be generally used as a carrier layer of a bonding material. For example, a bituminous waterproof sheet is composed of an asphalt size layer, a carrier layer and an isolation film layer, a preparation method thereof includes coating asphalt size on the carrier layer and then coating an isolation film on the asphalt size layer, and the bonding strength of the asphalt size layer and the carrier layer is shown as the peeling strength of the waterproof sheet. However, the surface polarity of the existing asphalt size layer is greatly different from that of the carrier layer. Under low temperature or even sub-zero temperature conditions, the bonding performance of the asphalt size layer and the carrier layer is obviously decreased, which directly affects the service life of the waterproof sheet in a low-temperature environment.

At present, methods used to solve the decrease of the performance of the polymeric film and the asphalt size under low temperature conditions generally include improving the polymeric film by adopting, for example, a corona treatment method or a modification treatment method. The corona treatment method can obviously improve the adhesion performance of a surface of the polymeric film and can enhance the bonding performance of the polymeric film and the bonding material in a short term, but the low-temperature bonding performance is inevitably decreased after a corona effect fades away. The modification treatment method includes modifying the polymeric film during production of the polymeric film to improve the adhesion ability of the polymeric film, but the overall performance of the polymeric film will also be obviously affected. The improvement of the polymeric film in the prior art cannot truly solve the problem of decrease of the bonding performance of the polymeric film and the asphalt size, and it is necessary to propose a new solution of improving the polymeric film to solve the above problem.

### SUMMARY

To solve the above technical problems, the objective of the present disclosure is to provide a functional film for enhancing the bonding strength of a polymeric film and asphalt size as well as a preparation method and application thereof. By arranging a performance improvement layer on the polymeric film, the low-temperature peeling strength of the functional film and an asphalt size layer is effectively improved by utilizing the bonding strength of the performance improvement layer and the polymeric film and the good bonding force of the performance improvement layer and the asphalt size layer, and the problem that the bonding performance of an existing polymeric film and an asphalt size layer is obviously reduced in a low-temperature environment is solved.

To achieve the above invention objective, technical solutions adopted by the present disclosure are as follows:
a functional film for enhancing the bonding strength of a polymeric film and asphalt size includes a polymeric film layer and a performance improvement layer coated on at least one surface of the polymeric film layer, the performance improvement layer includes a viscous layer serving as an inner layer and a passivation layer serving as an outer layer, the viscous layer is formed by evenly coating a first polymer emulsion, a layer number of the viscous layer is greater than or equal to 0, the passivation layer is formed by evenly coating a passivation emulsion, the passivation emulsion is obtained by mixing a second polymer emulsion, a filler and water, a layer number of the passivation layer is greater than or equal to 0, and the layer number of the viscous layer and the layer number of the passivation layer are not 0 simultaneously.

The polymeric film layer of the present disclosure is a polymeric film-based material, for example, a cross laminated film (CLF film), a high-temperature resistant polyester film (PET film), a polypropylene film (PP film), and a multilayer composite film (PP/PE/PP film, or PE/PP/PE film).

The polymer emulsion of the present disclosure refers to an emulsion with viscosity before curing. Preferably, the first polymer emulsion and the second polymer emulsion are both one or more of an acrylic emulsion, a styrene-butadiene emulsion, and a VAE emulsion; more preferably, the first polymer emulsion and the second polymer emulsion are both the acrylic emulsion, wherein the acrylic emulsion is composed of a copolymer of an acrylic monomer, water and an auxiliary agent, and the auxiliary agent includes an emulsifier, an initiator, a protective adhesive, a wetting agent, a preservative, a thickener and a defoamer, etc.; and more preferably, the first polymer emulsion and the second polymer emulsion are both a compound emulsion of a styrene-acrylic copolymer emulsion and a butadiene-styrene-acrylic copolymer emulsion. The first polymer emulsion and the second polymer emulsion may be the same and may also be different.

Preferably, the first polymer emulsion is a single-component emulsion, and a vitrification temperature of the first polymer emulsion≤30° C.; more preferably, the vitrification temperature of the first polymer emulsion≤20° C.; and more preferably, the vitrification temperature of the first polymer emulsion≤10° C., for example, the vitrification temperature of the first polymer emulsion is 0-10° C.

The vitrification temperature, that is, the glass transition temperature, refers to the temperature corresponding to the transformation of the polymer emulsion from a glassy state to a high-elastic state. The vitrification temperature of the polymer emulsion is related to the viscosity and the brittleness. Specifically, when the vitrification temperature is lower, the viscosity of the polymer emulsion is better; and when the vitrification temperature is higher, the viscosity of the polymer emulsion is decreased, and the brittleness is also increased after drying. The present disclosure provides a functional film capable of replacing an existing reinforcement layer, and the functional film needs to have the performance of repeatable winding and unwinding. In the present disclosure, when the functional film only includes the viscous layer and does not include the passivation layer, to achieve that the functional film has the function of winding transportation or winding storage and can be completely unwound for use again, the first polymer emulsion with a higher vitrification temperature is used to control the viscosity of the viscous layer to avoid that the functional film has a too sticky surface and cannot be wound. It should be noted that when the performance improvement layer contains the viscous layer and the passivation layer simultaneously, the viscous layer can be formed by coating the first polymer emulsion with a lower vitrification temperature, for example, the first polymer emulsion with a vitrification temperature of lower than 0° C.

Preferably, the first polymer emulsion is formed by mixing two or more emulsions with different vitrification temperatures; more preferably, the first polymer emulsion is formed by mixing an emulsion with a vitrification temperature≤20° C. and an emulsion with a vitrification temperature≥20° C.; and more preferably, the first polymer emulsion is formed by mixing an emulsion with a vitrification temperature≤10° C. and an emulsion with a vitrification temperature≥10° C. For the case that the performance improvement layer only contains the viscous layer, the surface brittleness of the functional film also needs to be concerned in addition to concerning the surface viscosity of the functional film. To balance the surface viscosity and brittleness, the first polymer emulsion is obtained by mixing an emulsion with a high vitrification temperature and an emulsion with a low vitrification temperature. The emulsion with the high vitrification temperature is conducive to reducing the viscosity of the emulsion with the low vitrification temperature, and meanwhile, the emulsion with the low vitrification temperature can reduce the brittleness of the emulsion with the high vitrification temperature, thereby achieving the balance between the viscosity and the brittleness and facilitating the winding of the functional film. It should be noted that when the performance improvement layer contains the viscous layer and the passivation layer simultaneously, the viscous layer can still use the first polymer emulsion with mixed components.

Preferably, the emulsion with the high vitrification temperature and the emulsion with the low vitrification temperature are mixed at a ratio of 1:(0.5-1.5). For example, the first polymer emulsion is formed by mixing the emulsion with a vitrification temperature≤10° C. and the emulsion with a vitrification temperature≥10° C. at the ratio of 1:(0.5-1.5).

Preferably, in the passivation emulsion, the filler includes one or more of a kaolin powder, a barium sulfate powder, and a titanium dioxide powder.

Preferably, in the passivation emulsion, a mass ratio of the second polymer emulsion, the filler and the water is 1:(0.5-2):(0.7-2.5); preferably, the mass ratio of the second polymer emulsion, the filler and the water is 1:(1.0-1.5):(1-2); and more preferably, the passivation emulsion further includes a functional auxiliary agent, and a mass ratio of the second polymer emulsion, the filler, the water and the functional auxiliary agent is 1:(0.5-2):(0.7-2.5): (0.02-0.1). In the passivation emulsion, a ratio of the second polymer emulsion to the filler is related to a vitrification temperature of the second polymer emulsion; when the vitrification temperature of the second polymer emulsion is lower, the filler that needs to be added is more; and when the vitrification temperature of the second polymer emulsion is higher, the filler that needs to be added is less. Preferably, the vitrification temperature of the second polymer emulsion≤20° C.; more preferably, the vitrification temperature of the second polymer emulsion≤10° C.; and preferably, the vitrification temperature of the second polymer emulsion is −10° C. to 10° C.

The passivation layer of the present disclosure serves as an outermost layer of the functional film and can adopt the second polymer emulsion with a lower vitrification temperature, the filler mainly solves the problem of too large surface viscosity of the functional film, the normal winding of the functional film is not affected even when the vitrification temperature of the second polymer emulsion is lower, and the second polymer emulsion plays the role of maintaining good bonding performance with the asphalt size layer. Since the passivation layer is heated when the asphalt size layer is coated, the crosslinking density of the passivation layer and the asphalt size layer is improved. Moreover, due to the existence of the filler, the passivation layer has a relatively rough surface and low compactness, so that the asphalt size can penetrate into the performance improvement layer through Brownian movement at high temperature to improve the interface compatibility, thereby improving the bonding strength of the passivation layer and the asphalt size layer.

Preferably, according to addition amounts calculated by mass percentage, the functional auxiliary agent includes one or more of 0.03-0.5% of a thicker, 0.1-0.5% of a wetting agent, 0.1-0.5% of a dispersant, 0.01-0.5% of a defoamer, and 0.01-0.1% of a preservative, and the balance of water.

Preferably, a mesh number of the filler≥2,000. When the mesh number of the filler is lower, a particle diameter of the filler is larger. Although the problem that the surface of the passivation layer is too viscous is solved, the peeling strength of the functional film and the asphalt size after bonding is decreased.

Preferably, the performance improvement layer further includes a transition layer, the layer number of the viscous layer is greater than or equal to 1, the layer number of the passivation layer is greater than or equal to 1, the transition layer is arranged between the viscous layer and the passivation layer, the transition layer is formed by evenly coating a third polymer emulsion, and the third polymer emulsion is prepared by mixing two or more emulsions with different vitrification temperatures; more preferably, the third polymer emulsion is prepared by mixing an emulsion with a vitrification temperature≤20° C. and an emulsion with a vitrification temperature≥20° C.; and more preferably, the third polymer emulsion is prepared by mixing the emulsion with the vitrification temperature≤20° C. and the emulsion with the vitrification temperature≥20° C. at a ratio of 1:(0.6-1).

Preferably, the third polymer emulsion is one or more of an acrylic emulsion, a styrene-butadiene emulsion, and a VAE emulsion, or the third polymer emulsion may be a compound emulsion of a styrene-acrylic copolymer emulsion and a butadiene-styrene-acrylic copolymer emulsion; and more preferably, the third polymer emulsion is the acrylic emulsion, wherein types of the first polymer emulsion, the second polymer emulsion and the third polymer emulsion may be the same and may also be different.

In a second aspect of the present disclosure, the present disclosure provides a method for preparing afunctional film, which is used for preparing the aforementioned functional film for enhancing the bonding strength of the polymeric film and asphalt size and includes the following steps:
unwinding the polymeric film layer, sequentially coating the first polymer emulsion and/or the passivation emulsion on the polymeric film layer to serve as the performance improvement layer, and conducting winding for later use after the performance improvement layer is dried;
wherein when the first polymer emulsion or the passivation emulsion is coated, a coating amount on the polymeric film layer per square meter≥20 g/m²; and more preferably, the coating amount on the polymeric film layer per square meter≥30 g/m².

When the performance improvement layer includes the transition layer and when the third polymer emulsion is coated, a coating amount on the polymeric film layer per square meter≥20 g/m²; and more preferably, the coating amount on the polymeric film layer per square meter≥30 g/m².

For the case that a layer number of the performance improvement layer is two or more, after one layer is coated, the next layer can be immediately coated without waiting for curing.

In a third aspect of the present disclosure, the present disclosure provides an application of afunctional film, wherein asphalt size in a flowing state is coated on the aforementioned functional film.

It should be noted that at high temperature, the viscous layer and the passivation layer are not compact, and the asphalt size in the flowing state has an extremely high temperature. When the asphalt size is coated on the functional film, molecules in the asphalt size will penetrate into the non-compact performance improvement layer through Brownian movement at high temperature to improve the interface compatibility between the two, thereby solving the problem of too low peeling strength caused by interface incompatibility between the asphalt size and a polymeric film. Compared with the viscous layer, the passivation layer has a higher degree of non-compactness. Therefore, even when the viscosity of the passivation layer is decreased, the bonding strength of the passivation layer and the asphalt size is not inferior to the bonding strength of the asphalt size and the viscous layer.

In a fourth aspect of the present disclosure, the present disclosure provides a waterproof system, which includes the aforementioned functional film.

Preferably, with a building surface as a base surface, the waterproof system sequentially includes, from bottom to top, a first asphalt size layer, a first functional film layer, a second asphalt size layer, . . . , an N-th functional film layer and an (N+1)th asphalt size layer, wherein N is a positive integer greater than or equal to 1.

In a fifth aspect of the present disclosure, the present disclosure provides a waterproof sheet, which includes the aforementioned functional film.

### Beneficial Effects

According to the present disclosure, the novel functional film is formed by adding the performance improvement layer on the conventional polymeric film, and the low-temperature bonding performance of the sheet and the waterproof system using the functional film as a carrier is improved. When the functional film of the present disclosure is bonded to the asphalt size, the interface compatibility between the functional film and the asphalt size is improved, the service life of a product thereof in the low-temperature environment is greatly prolonged, and a phenomenon of a fading effect of, for example, a corona treatment method, will not occur. The performance improvement layer of the present disclosure includes the viscous layer and the passivation layer, and the performance improvement layer adopts the polymer emulsion with the appropriate vitrification temperature. On the premise of ensuring the bonding strength of the performance improvement layer and a carrier layer, the surface viscosity and the brittleness of the functional film are balanced, and the problems of difficult winding of the polymeric film after coating the polymer emulsion as well as inconvenient unwinding caused by bonding due to a too long storage time after winding or damage of the performance improvement layer caused by unwinding are solved.

The functional film of the present disclosure has a simple preparation method and a low cost, is suitable for large-scale industrial production, and is conducive to solving the problem of poor low-temperature durability of existing sheets.

### DETAILED DESCRIPTION OF THE EMBODIMENTS

Specific embodiments of the present disclosure are illustrated below. Obviously, the described embodiments below merely shows only some embodiments of the present disclosure, and for those skilled in the art, other embodiments can also be obtained without exerting creative efforts according to these embodiments.

The surface polarity of an existing reinforcement layer (e.g., a polymeric film) is greatly different from that of asphalt size. The conventional polymeric film is bonded to the asphalt size in a high-temperature environment, but the bonding performance of the polymeric film and the asphalt size is obviously decreased in a low-temperature environment.

To solve the defect of insufficient low-temperature bonding performance of the conventional polymeric film and the asphalt size, the present disclosure provides a functional film for enhancing the bonding strength of the polymeric film and the asphalt size. The functional film includes a polymeric film layer and a performance improvement layer coated on at least one surface of the polymeric film layer. To facilitate the description below, the performance improvement layer or related structures mentioned below are all coated on the same surface of the polymeric film layer.

The performance improvement layer includes a viscous layer serving as an inner layer and a passivation layer serving as an outer layer, the viscous layer is formed by evenly coating a first polymer emulsion, a layer number of the viscous layer is greater than or equal to 0, the passivation layer is formed by evenly coating a passivation emulsion, the passivation emulsion is obtained by mixing a second polymer emulsion, a filler and water, a layer number of the passivation layer is greater than or equal to 0, and the layer number of the viscous layer and the layer number of the passivation layer are not 0 simultaneously.

In the present disclosure, the polymeric film layer is a polymeric film-based material, for example, a cross laminated film (CLF film), a high-temperature resistant polyester film (PET film), a polypropylene film (PP film), and a multilayer composite film (PP/PE/PP film, or PE/PP/PE film).

The functional film of the present disclosure at least includes the following three structures.

In a first structure, the performance improvement layer only contains the viscous layer, and the layer number of the viscous layer is at least one.

In a second structure, the performance improvement layer only contains the passivation layer, and the layer number of the passivation layer is at least one.

In a third structure, the performance improvement layer contains the viscous layer and the passivation layer, the viscous layer serves as the inner layer, the passivation layer serves as the outer layer, and the layer number of the viscous layer and the layer number of the passivation layer are both at least one.

The present disclosure actually provides a novel composite reinforcement layer, which has the function of convenient winding transportation or winding storage.

For the first structure, the viscosity of the viscous layer needs to be controlled. When a surface of the viscous layer is too viscous, the functional film is difficult to wind or cannot be completely unwound for use again. In the present disclosure, the first polymer emulsion may be a single-component emulsion, winding of the functional film is achieved by adopting the first polymer emulsion with a higher vitrification temperature, and the vitrification temperature of the first polymer emulsion≤30° C.; preferably, the vitrification temperature of the first polymer emulsion≤20° C.; and more preferably, the vitrification temperature of the first polymer emulsion≤10° C., for example, the vitrification temperature of the first polymer emulsion is 0-10° C.

It is easy to understand that for the case of two or more layers of the viscous layers, the vitrification temperature of the outermost viscous layer is greater than the vitrification temperature of the remaining viscous layers, for example, the vitrification temperature of the outermost viscous layer is 0-10° C., and the vitrification temperature of the remaining viscous layer≤0° C.

In addition, for the problem of winding of the functional film, when the first polymer emulsion with a high vitrification temperature is adopted, the surface brittleness of the functional film is also increased, and the surface will be cracked or even broken during winding. In the present disclosure, the first polymer emulsion may also be an emulsion with mixed components. For example, the first polymer emulsion is formed by mixing two or more emulsions with different vitrification temperatures; preferably, the first polymer emulsion is formed by mixing an emulsion with a vitrification temperature≤20° C. and an emulsion with a vitrification temperature≥20° C.; and more preferably, the first polymer emulsion is formed by mixing an emulsion with a vitrification temperature≤10° C. and an emulsion with a vitrification temperature≥10° C. An emulsion with a high vitrification temperature and an emulsion with a low vitrification temperature are mixed at a ratio of 1:(0.5-1.5). For example, the first polymer emulsion is formed by mixing the emulsion with the vitrification temperature≤10° C. and the emulsion with the vitrification temperature≥10° C. at the ratio of 1:(0.5-1.5).

The first polymer emulsion with the mixed components can balance the brittleness and the viscosity. The emulsion with the high vitrification temperature is conducive to reducing the viscosity of the emulsion with the low vitrification temperature, and meanwhile, the emulsion with the low vitrification temperature can reduce the brittleness of the emulsion with the high vitrification temperature, thereby achieving the balance between the viscosity and the brittleness and facilitating the winding of the functional film.

It is easy to understand that for the case of two or more layers of viscous layers, the outermost viscous layer can be formed by coating the first polymer emulsion with the mixed components, and the remaining viscous layers may be formed by coating the first polymer emulsion with the single component and the low vitrification temperature.

For the second structure, the passivation layer plays the role of preventing the functional film from being too viscous to facilitate winding. The passivation emulsion is prepared by mixing the second polymer emulsion, the filler and the water, wherein a mass ratio of the second polymer emulsion, the filler and the water is 1:(0.5-2):(0.7-2.5); preferably, the mass ratio of the second polymer emulsion, the filler and the water is 1:(1.0-1.5):(1-2); more preferably, the passivation emulsion further includes a functional auxiliary agent, and a mass ratio of the second polymer emulsion, the filler, the water and the functional auxiliary agent is 1:(0.5-2):(0.7-2.5):(0.02-0.1), wherein the filler is a commonly used ore powder, for example, one or more of a kaolin powder, a barium sulfate powder, and a titanium dioxide powder, and a mesh number of the filler≥2,000; and according to addition amounts calculated by mass percentage, the functional auxiliary agent includes one or more of 0.03-0.5% of a thicker, 0.1-0.5% of a wetting agent, 0.1-0.5% of a dispersant, 0.01-0.5% of a defoamer, and 0.01-0.1% of a preservative, and the balance of water, for example, calculated by mass percentage, the the functional auxiliary agent is composed of 0.1% of the dispersant and 99.8% of the water.

In the passivation emulsion, the second polymer emulsion plays the role of improving the bonding performance of the passivation layer and the polymeric film layer as well as the bonding performance of the passivation layer and the asphalt size layer. Therefore, a vitrification temperature of the second polymer emulsion cannot be too high. For example, the vitrification temperature of the second polymer emulsion≤20° C.; preferably, the vitrification temperature of the second polymer emulsion≤10° C.; and more preferably, the vitrification temperature of the second polymer emulsion is −10° C. to 10° C., for example, the vitrification temperature of the second polymer emulsion is −5° C. In addition, the second polymer emulsion may also be mixed components. For example, the second polymer emulsion is formed by mixing an emulsion with a vitrification temperature≤10° C. and an emulsion with a vitrification temperature≥10° C. at the ratio of 1:(0.5-1.5).

In the passivation emulsion, the filler plays the role of reducing the surface viscosity of the functional film. Since the passivation layer reduces the viscosity by adding the filler, the viscosity of the second polymer emulsion may be higher than the viscosity of the first polymer emulsion. The ratio of the second polymer emulsion to the filler is related to the vitrification temperature of the second polymer emulsion; when the vitrification temperature of the second polymer emulsion is lower, the filler that needs to be added is more; and when the vitrification temperature of the second polymer emulsion is higher, the filler that needs to be added is less.

For the third structure, the viscous layer serves as the inner layer and plays the role of maintaining the bonding strength of the performance improvement layer and the polymeric film layer. Since the viscous layer has no impact on winding of the functional film, the viscous layer can be formed by coating the first polymer emulsion with the lower vitrification temperature, for example, the first polymer emulsion with the vitrification temperature of lower than 0° C.

The passivation layer serves as the outer layer and plays the role of solving the problem of winding of the functional film, which has same components as the passivation layer in the second structure.

On the basis of the third structure, further, the performance improvement layer also includes a transition layer, the transition layer is arranged between the viscous layer and the passivation layer, the transition layer is formed by evenly coating a third polymer emulsion, and the third polymer emulsion is prepared by mixing two or more emulsions with different vitrification temperatures; more preferably, the third polymer emulsion is prepared by mixing an emulsion with a vitrification temperature≤20° C. and an emulsion with a vitrification temperature≥20° C.; and more preferably, the third polymer emulsion is prepared by mixing the emulsion with the vitrification temperature≤20° C. and the emulsion with the vitrification temperature≥20° C. at 1:(0.6-1).

The first polymer emulsion, the second polymer emulsion and the third polymer emulsion may be existing conventional organic emulsions with viscosity, provided that vitrification temperature requirements of the present disclosure are met, for example, one or more of an acrylic emulsion, a styrene-butadiene emulsion, and a VAE emulsion, and alternatively, the first polymer emulsion, the second polymer emulsion and the third polymer emulsion are all a compound emulsion of a styrene-acrylic copolymer emulsion and a butadiene-styrene-acrylic copolymer emulsion. More preferably, the first polymer emulsion, the second polymer emulsion and the third polymer emulsion are all an acrylic resin emulsion, and a product obtained by mixing a copolymer of an acrylate monomer, an auxiliary agent and water is selected as the acrylic emulsion, wherein the auxiliary agent may include an emulsifier, an initiator, a protective adhesive, a wetting agent, a preservative, a thickener and a defoamer. Types of the first polymer emulsion, the second polymer emulsion and the third polymer emulsion may be the same and may also be different.

In the present disclosure, whether for the first structure, the second structure or the third structure, the bonding strength of the functional film and the asphalt size is improved for the following reasons.

On the one hand, the bonding force of the viscous emulsion itself and the asphalt size is utilized in the present disclosure; and on the other hand, the bonding force of the viscous emulsion and the polymeric film is improved by means of the good compatibility between the viscous emulsion and the polymeric film. A bonding principle is not a simple superposition effect of the two, but a compound effect of mutual influence, that is: the mutual crosslinking density of the performance improvement layer and the polymeric film is increased at the high temperature of 145° C. to 170° C. (that is, the temperature of the asphalt size), the bonding strength of the performance improvement layer and the polymeric film is improved, and the asphalt size itself and the viscous emulsion have a good bonding force. Therefore, the principle of improvement of the bonding force of the polymeric film and the asphalt size is summarized as follows: an asphalt coating is bonded to the performance improvement layer, and the performance improvement layer is bonded to the polymeric film, thereby improving the peeling strength of the asphalt coating and the functional film.

In addition, the viscous layer and the passivation layer of the present disclosure are both non-compact. When the outermost viscous layer or the passivation layer is in contact with the high-temperature asphalt size, the asphalt size will penetrate into the viscous layer and the passivation layer, thereby improving the interface compatibility of the asphalt size and the functional film and further improving the bonding performance. Since the passivation layer contains the filler, the degree of non-compactness thereof is higher than that of the viscous layer. Even when the viscosity of the passivation layer itself is decreased, the bonding strength of the passivation layer and the asphalt size is not superior to the bonding strength of the asphalt size and the viscous layer.

The present disclosure also provides a method for preparing the above functional film, which specifically includes the following steps:
unwinding the polymeric film layer, sequentially coating the first polymer emulsion and/or the passivation emulsion on the polymeric film layer to serve as the performance improvement layer, and conducting winding for later use after the performance improvement layer is dried;
wherein, when the first polymer emulsion or the passivation emulsion is coated, a coating amount on the polymeric film layer per square meter≥20 g/m²; and more preferably, the coating amount on the polymeric film layer per square meter≥30 g/m².

When the performance improvement layer includes the transition layer and when the third polymer emulsion is coated, a coating amount on the polymeric film layer per square meter≥20 g/m²; and more preferably, the coating amount on the polymeric film layer per square meter≥30 g/m².

For the case that a layer number of the performance improvement layer is two or more, after one layer is coated, the next layer can be immediately coated without waiting for curing.

The drying after the completion of coating may be normal-temperature drying and may also be high-temperature rapid drying, for example, drying at the temperature of 100-140° C.; preferably, the drying after the completion of coating is conducted at the temperature of 120° C., and a drying speed after the completion of coating is 15-30 m/min; and more preferably, the drying speed after the completion of coating is 20 m/min.

The technical solutions of the present disclosure are introduced below in detail through specific examples. A polymeric film is bonded to modified asphalt size to test the peeling strength in the examples and comparative examples, wherein calculated by mass part, the modified asphalt size used in the following examples is prepared by 55 parts of asphalt, 13 parts of softening oil (i.e., an oil product), 7 parts of SBS3411, 3 parts of SBR, 5 parts of a waste rubber powder, 0.75 part of a stabilizer (i.e., a modification auxiliary agent), 2 parts of carbon black (i.e., a filler) and 20 parts of a stone powder (i.e., a filler). A method for preparing the modified asphalt size is as follows: conducting heating to 150-180° C. after mixing the asphalt and the oil product, feeding the SBS and the SBR, conducting stirring for uniform dispersion for 1-2 hours, feeding the waste rubber powder and the modification auxiliary agent for modification for 1 hour, feeding the filler after grinding for uniform dispersion, and conducting physical mixing for 1.5 hours to prepare the modified asphalt size; wherein the temperature is maintained at 145-170° C. to maintain the modified asphalt size in a flowing state for later use. a polymeric film layer (i.e. the polymeric film) used in the following examples is a high-temperature resistant polyester film (PET film), and a functional auxiliary agent used in the following examples is composed of 0.1 wt % of BYK-024, 0.05 wt % of Kathon™ LXE, and 99.85 wt % of water, wherein the BYK-024 is served as a defoamer and is purchased from BYK-Chemie GmbH, the Kathon™ LXE is served as a preservative and is purchased from Dow Chemical Company

### EXAMPLE

### Example 1

The coating of one layer of an acrylic emulsion with a single component as a viscous layer was taken as an example.
(1) A polymeric film layer was unwound and coated with one layer of a polymer emulsion to serve as a performance improvement layer with a coating amount of 40 g/m², and then dried at a drying temperature of 120° C. and a drying speed of 20 m/min to prepare a novel functional film, which was wound for later use.
(2) The functional film was unwound, the performance improvement layer was continuously coated with the modified asphalt size in a flowing state by using a roll coating process, and film coating, cooling and winding were conducted; wherein a vitrification temperature of the acrylic emulsion was 20° C.

### Example 2

The coating of one layer of an acrylic emulsion with a single component as a viscous layer was taken as an example.

A preparation method was the same as that in Example 1, wherein a vitrification temperature of the acrylic emulsion was 9° C.

### Example 3

The coating of one layer of an acrylic emulsion with mixed components as a viscous layer was taken as an example.

A preparation method was the same as that in Example 1, wherein the acrylic emulsion was prepared by mixing an emulsion with a vitrification temperature of −7° C. and an emulsion with a vitrification temperature of 56° C. at a mass ratio of 1:1.

### Example 4

The coating of one layer of an acrylic emulsion with mixed components as a viscous layer was taken as an example.

A preparation method was the same as that in Example 1, wherein the acrylic emulsion was prepared by mixing an emulsion with a vitrification temperature of −15° C. and an emulsion with a vitrification temperature of 105° C. at a mass ratio of 1:1.2.

### Example 5

The coating of one layer of an acrylic emulsion with mixed components as a viscous layer was taken as an example.

A preparation method was the same as that in Example 1, wherein the acrylic emulsion was prepared by mixing an emulsion with a vitrification temperature of 9° C. and an emulsion with a vitrification temperature of 20° C. at a mass ratio of 1:0.8.

### Example 6

The coating of one layer of styrene-butadiene latex (a styrene-butadiene emulsion) with a single component as a viscous layer was taken as an example.

A preparation method was the same as that in Example 1, wherein a vitrification temperature of the styrene-butadiene latex was 14° C.

### Example 7

The coating of one layer of a passivation layer was taken as an example.

A preparation method was the same as that in Example 1, wherein a passivation emulsion was formed by mixing an acrylic emulsion with a vitrification temperature of 9° C., a 2000-mesh kaolin powder, a functional auxiliary agent and water at 1:1:1:1.

### Example 8

The coating of one layer of a passivation layer was taken as an example.

A preparation method was the same as that in Example 1, wherein a passivation emulsion was formed by mixing an acrylic emulsion with a vitrification temperature of −4° C., a 2000-mesh kaolin powder, a functional auxiliary agent and water at 1:1.5:1:1.

### Example 9

The coating of one layer of a passivation layer was taken as an example.

A preparation method was the same as that in Example 1, wherein a passivation emulsion was formed by mixing an acrylic emulsion with a vitrification temperature of −15° C., a 2000-mesh kaolin powder, a functional auxiliary agent and water at 1:2:1:1.

### Example 10

The coating of two layers of acrylic emulsions with a single component as viscous layers was taken as an example.
(1) A polymeric film layer was unwound, sequentially coated with two layers of the emulsions to serve as a performance improvement layer with a coating amount of 30 g/m² for each layer, and then dried at a drying temperature of 120° C. and a drying speed of 20 m/min to prepare a novel functional film, which was wound for later use.
(2) The functional film was unwound, the performance improvement layer was continuously coated with the modified asphalt size in a flowing state by using a roll coating process, and film coating, cooling and winding were conducted; wherein a vitrification temperature of the acrylic emulsion on the first layer (inner layer) was −15° C., and a vitrification temperature of the acrylic emulsion on the second layer (outer layer) was 20° C.

### Example 11

The coating of two layers of acrylic emulsions as viscous layers was taken as an example, wherein the first layer was coated with the acrylic emulsion with a single component, and the second layer was coated with the acrylic emulsion with mixed components.

A preparation method was the same as that in Example 10, wherein a vitrification temperature of the acrylic emulsion on the first layer (inner layer) was −22° C., and the acrylic emulsion on the second layer was prepared by mixing an emulsion with a vitrification temperature of 9° C. and an emulsion with a vitrification temperature of 20° C. at a mass ratio of 1:0.8.

### Example 12

The coating of one layer of a viscous layer and one layer of a passivation layer was taken as an example.

A preparation method was the same as that in Example 10, wherein the first layer (inner layer) was coated with an acrylic emulsion with a vitrification temperature of −15° C., the second layer (outer layer) was coated with a passivation emulsion, and the passivation emulsion was formed by mixing an acrylic emulsion with a vitrification temperature of 9° C., a 2000-mesh kaolin powder, a functional auxiliary agent and water at 1:1:1:1.

### Example 13

The coating of one layer of a viscous layer, one layer of a transition layer and one layer of a passivation layer was taken as an example.
(1) A polymeric film layer was unwound, sequentially coated with three layers of emulsions to serve as a performance improvement layer with a coating amount of 30 g/m² for each layer, and then dried at a drying temperature of 120° C. and a drying speed of 20 m/min to prepare a novel functional film, which was wound for later use.
(2) The functional film was unwound, the performance improvement layer was continuously coated with the modified asphalt size in a flowing state by using a roll coating process, and film coating, cooling and winding were conducted; wherein the first layer (inner layer) was formed by coating an acrylic emulsion with a vitrification temperature of −15° C., the second layer (middle layer) was formed by coating an acrylic emulsion that was formed by mixing an acrylic emulsion with a vitrification temperature of −7° C. and an acrylic emulsion with a vitrification temperature of 56° C. at a mass ratio of 1:1, the third layer (outer layer) was formed by coating a passivation emulsion, and the passivation emulsion was formed by mixing an acrylic emulsion with a vitrification temperature of 9° C., a 2000-mesh kaolin powder, a functional auxiliary agent and water at 1:1:1:1.

### COMPARATIVE EXAMPLE

### Comparative Example 1

Compared with Example 1, an emulsion was not coated. Specifically, a polymeric film layer was unwound, a surface of a polymeric inlay was coated with modified asphalt size by using a roll coating process at 150° C., and film coating, cooling and winding were conducted.

### Comparative Example 2

One layer of an acrylic emulsion with a single component was coated to serve as a viscous layer. A preparation method was the same as that in Example 1, wherein a vitrification temperature of the acrylic emulsion was −5° C.

### Comparative Example 3

One layer of an acrylic emulsion with a single component was coated to serve as a viscous layer. A preparation method was the same as that in Example 1, wherein a vitrification temperature of the acrylic emulsion was 40° C.

### Comparative Example 4

One layer of an acrylic emulsion with mixed components was coated to serve as a viscous layer. A preparation method was the same as that in Example 1, wherein the acrylic emulsion was prepared by mixing an emulsion with a vitrification temperature of −4° C. and an emulsion with a vitrification temperature of 9° C. at a mass ratio of 1:1.5.

### Comparative Example 5

One layer of an acrylic emulsion with mixed components was coated to serve as a viscous layer. A preparation method was the same as that in Example 1, wherein the acrylic emulsion was prepared by mixing an emulsion with a vitrification temperature of −15° C. and an emulsion with a vitrification temperature of 65° C. at a mass ratio of 1:2.

### Comparative Example 6

One layer of an acrylic emulsion with mixed components was coated to serve as a viscous layer. A preparation method was the same as that in Example 1, wherein the acrylic emulsion was prepared by mixing an emulsion with a vitrification temperature of −22°° C. and an emulsion with a vitrification temperature of 105° C. at a mass ratio of 1:0.2.

### Comparative Example 7

One layer of a passivation emulsion was coated to serve as a passivation layer. A preparation method was the same as that in Example 1, wherein the passivation emulsion was formed by mixing an acrylic emulsion with a vitrification temperature of 9° C., a 2000-mesh kaolin powder, a functional auxiliary agent and water at 1:3:1:1.

### Comparative Example 8

One layer of a passivation emulsion was coated to serve as a passivation layer. A preparation method was the same as that in Example 1, wherein the passivation emulsion was formed by mixing an acrylic emulsion with a vitrification temperature of 9° C., a 325-mesh kaolin powder, a functional auxiliary agent and water at 1:1:1:1.

### Comparative Example 9

One layer of a passivation emulsion was coated to serve as a passivation layer. A preparation method was the same as that in Example 1, wherein the passivation emulsion was formed by mixing an acrylic emulsion with a vitrification temperature of −15° C., a 2000-mesh kaolin powder, a functional auxiliary agent and water at 2:1:1:1.

### Comparative Example 10

Two layers of acrylic emulsions with a single component were coated to serve as viscous layers. A preparation method was the same as that in Example 10, wherein a vitrification temperature of the acrylic emulsion on the inner layer was −15° C., and a vitrification temperature of the acrylic emulsion on the outer layer was −4° C.

### Comparative Example 11

Two layers of acrylic emulsions were coated to serve as viscous layers, wherein the inner layer was the acrylic emulsion with a single component, and the outer layer was the acrylic emulsion with mixed components. A preparation method was the same as that in Example 10, wherein a vitrification temperature of the acrylic emulsion on the inner layer was −15° C., and the acrylic emulsion on the outer layer was prepared by mixing an emulsion with a vitrification temperature of −15° C. and an emulsion with a vitrification temperature of 65° C. at a mass ratio of 1:2.

### Comparative Example 12

One layer of a viscous layer and one layer of a passivation layer were coated. A preparation method was the same as that in Example 10, wherein a vitrification temperature of an acrylic emulsion on the inner layer was −15° C., and a passivation emulsion on the outer layer was formed by mixing an acrylic emulsion with a vitrification temperature of −15° C., a 2000-mesh kaolin powder, a functional auxiliary agent and water at 2:1:1:1.

The bonding performance of modified asphalt size and a polymeric inlay in modified bituminous waterproof sheets prepared from the composite reinforcement layer of the present disclosure at low temperature (−5° C. to 5° C.) was tested according to a test method in the standard GB23441-2009 “Self-adhering Polymer Modified Bituminous Waterproof Sheet”. Test results are shown in the following table, wherein the temperature in the table refers to a vitrification temperature (Tg).

| | | | | | Peeling |
|---|---|---|---|---|---|
| | | | | | strength |
| | | | | | of a |
| | Layer | | Component | | water- |
| | number | | of each | Surface | proof |
| | of a | | layer of the | viscosity of | sheet |
| | performance | | performance | a composite | at |
| | improvement | | improvement | reinforcement | 0C° |
| | layer | | layer | layer | N/mm |
| Exam- | One | / | Acrylic emulsion | A surface is not | 2.5 |
| ple 1 | layer | | with | viscous, can be | |
| | | | 20° C. | wound, | |
| | | | | and has no | |
| | | | | cracks after | |
| | | | | winding | |
| Exam- | One | / | Acrylic emulsion | A surface is not | 3.0 |
| ple 2 | layer | | with 9° C. | viscous, can be | |
| | | | | wound, | |
| | | | | and has no | |
| | | | | cracks after | |
| | | | | winding | |
| Exam- | One | / | Acrylic emulsion | A surface is not | 2.8 |
| ple 3 | layer | | with −7° C. | viscous, can be | |
| | | | and an acrylic | wound, | |
| | | | emulsion | and has no | |
| | | | with 56° C. | cracks after | |
| | | | (1:1) | winding | |
| Exam- | One | / | Acrylic emulsion | A surface is not | 2.0 |
| ple 4 | layer | | with −15° C. and | viscous, can be | |
| | | | an acrylic | wound, | |
| | | | emulsion | and has no | |
| | | | with 105° C. | cracks after | |
| | | | (1:1.2) | winding | |
| Exam- | One | / | Acrylic emulsion | A surface is not | 2.6 |
| ple 5 | layer | | with 9° C. and | viscous, can be | |
| | | | an acrylic | wound, | |
| | | | emulsion | and has no | |
| | | | with 20° C. | cracks after | |
| | | | (1:0.8) | winding | |
| Exam- | One | / | Styrene-butadiene | A surface is not | 2.5 |
| ple 6 | layer | | emulsion | viscous, can be | |
| | | | with 14° C. | wound, | |
| | | | | and has no | |
| | | | | cracks after | |
| | | | | winding | |
| Exam- | One | / | Acrylic emulsion | A surface is not | 2.4 |
| ple 7 | layer | | with 9° C., a | viscous, can be | |
| | | | 2000-mesh | wound, | |
| | | | kaolin powder, a | and has no | |
| | | | functional | cracks after | |
| | | | auxiliary | winding | |
| | | | agent and water | | |
| | | | (1:1:1:1) | | |
| Exam- | One | / | Acrylic emulsion | A surface is not | 2.6 |
| ple 8 | layer | | with −4° C., a | viscous, can be | |
| | | | 2000-mesh | wound, | |
| | | | kaolin powder, a | and has no | |
| | | | functional | cracks after | |
| | | | auxiliary | winding | |
| | | | agent and water | | |
| | | | (1:1.5:1:1) | | |
| Exam- | One | / | Acrylic emulsion | A surface is not | 2.7 |
| ple 9 | layer | | with −15° C., | viscous, can be | |
| | | | a 2000-mesh | wound, | |
| | | | kaolin powder, a | and has no | |
| | | | functional | cracks after | |
| | | | auxiliary | winding | |
| | | | agent and water | | |
| | | | (1:2:1:1) | | |
| Exam- | Two | Inner | Acrylic emulsion | A surface is not | 2.5 |
| ple 10 | layers | layer | with −15° C. | viscous, can be | |
| | | Outer | Acrylic | wound, | |
| | | layer | emulsion with | and has no | |
| | | | 20° C. | cracks after | |
| | | | | winding | |
| Exam- | Two | Inner | Acrylic emulsion | A surface is not | 2.7 |
| ple 11 | layers | layer | with −22° C. | viscous, can be | |
| | | Outer | Acrylic | wound, | |
| | | layer | emulsion with | and has no | |
| | | | 9° C. and | cracks after | |
| | | | an acrylic | winding | |
| | | | emulsion at 20° C. | | |
| | | | (1:0.8) | | |
| Exam- | Two | Inner | Acrylic emulsion | A surface is not | 2.5 |
| ple 12 | layers | layer | with −15° C. | viscous, can be | |
| | | Outer | Acrylic | wound, | |
| | | layer | emulsion with | and has no | |
| | | | 9° C., a | cracks after | |
| | | | 2000-mesh | winding | |
| | | | kaolin powder, a | | |
| | | | functional | | |
| | | | auxiliary | | |
| | | | agent and water | | |
| | | | (1:1:1:1) | | |
| Exam- | Three | Inner | Acrylic emulsion | A surface is not | 2.0 |
| ple 13 | layers | layer | with −15° C. | viscous, can be | |
| | | middile | Acrylic emulsion | wound, | |
| | | layer | with −7° C. | and has no | |
| | | | and an acrylic | cracks after | |
| | | | emulsion at | winding | |
| | | | 56° C. (1:1) | | |
| | | Outer | Acrylic emulsion | | |
| | | layer | with 9° C., | | |
| | | | a 2000-mesh | | |
| | | | kaolin powder, a | | |
| | | | functional | | |
| | | | auxiliary | | |
| | | | agent and water | | |
| | | | (1:1:1:1) | | |
| Com- | One | / | / | / | |
| par- | layer | | | | |
| ative | | | | | |
| Exam- | | | | | |
| ple 1 | | | | | |
| Com- | One | / | Acrylic | A surface | 3.3 |
| par- | layer | | emulsion with | is viscous | |
| ative | | | −5° C. | and cannot be | |
| Exam- | | | | wound | |
| ple 2 | | | | | |
| Com- | One | / | Acrylic | A surface is not | 1.0 |
| par- | layer | | emulsion with | viscous, but has | |
| ative | | | 40° C. | higher | |
| Exam- | | | | brittleness, | |
| ple 3 | | | | and cannot be | |
| | | | | wound | |
| Com- | One | / | Acrylic emulsion | A surface | 3.6 |
| par- | layer | | with −4° C. and | is viscous | |
| ative | | | an acrylic | and cannot be | |
| Exam- | | | emulsion with | wound | |
| ple 4 | | | 9° C. (1:1.5) | | |
| Com- | One | / | Acrylic emulsion | A surface is not | 1.0 |
| par- | layer | | with −15° C. | viscous, but has | |
| ative | | | and an acrylic | higher | |
| Exam- | | | emulsion with | brittleness, | |
| ple 5 | | | 65° C. (1:2) | and cannot be | |
| | | | | wound | |
| Com- | One | / | Acrylic emulsion | A surface | 4.0 |
| par- | layer | | with −22° C. | is viscous | |
| ative | | | and an acrylic | and cannot be | |
| Exam- | | | emulsion with | wound | |
| ple 6 | | | 105° C. (1:0.2) | | |
| Com- | One | / | Acrylic | A surface is not | 1.3 |
| par- | layer | | emulsion with | viscous | |
| ative | | | 9° C., a | and can be | |
| Exam- | | | 2000-mesh | wound | |
| ple 7 | | | kaolin powder, a | | |
| | | | functional | | |
| | | | auxiliary | | |
| | | | agent and water | | |
| | | | (1:3:1:1) | | |
| Com- | One | / | Acrylic emulsion | A surface is not | 1.8 |
| par- | layer | | with 9° C., a | viscous | |
| ative | | | 325-mesh kaolin | and can be | |
| Exam- | | | powder, a | wound | |
| ple 8 | | | functional | | |
| | | | auxiliary | | |
| | | | agent and | | |
| | | | water (1:1:1:1) | | |
| Com- | One | / | Acrylic emulsion | A surface | 3.0 |
| par- | layer | | with −15° C., | is viscous | |
| ative | | | a 2000-mesh | and cannot be | |
| Exam- | | | kaolin powder, a | wound | |
| ple 9 | | | functional | | |
| | | | auxiliary | | |
| | | | agent and water | | |
| | | | (2:1:1:1) | | |
| Com- | Two | Inner | Acrylic | A surface | 4.0 |
| par- | layers | layer | emulsion with | is viscous | |
| ative | | Outer | −15° C. | and cannot be | |
| Exam- | | layer | Acrylic emulsion | wound | |
| ple 10 | | | with −4° C. | | |
| Com- | Two | Inner | Acrylic emulsion | A surface is not | 1.1 |
| par- | layers | layer | with −15° C. | viscous, but has | |
| ative | | Outer | Acrylic emulsion | higher | |
| Exam- | | layer | with −15° C. | brittleness, | |
| ple 11 | | | and an acrylic | and cannot be | |
| | | | emulsion with | wound | |
| | | | 65° C. (1:2) | | |
| Com- | Two | Inner | Acrylic emulsion | A surface | 3.6 |
| par- | layers | layer | with −15° C. | is viscous | |
| ative | | Outer | Acrylic emulsion | and cannot be | |
| Exam- | | layer | with −15° C., a | wound | |
| ple 12 | | | 2000-mesh kaolin | | |
| | | | powder, | | |
| | | | a functional | | |
| | | | auxiliary | | |
| | | | agent and | | |
| | | | water (2:1:1:1) | | |

According to the comparison between Examples 1-13 and Comparative Example 1, it can be seen that the coating of the performance improvement layer on the polymeric film layer is conducive to improving the low-temperature bonding performance of the sheets. Since the performance improvement layer is arranged on the existing polymeric film layer in the present disclosure, the phenomenon of a fading effect of, for example, a corona treatment method, will not occur. In the present disclosure, the problem of too high surface viscosity of the functional film is solved by adopting a polymer emulsion with a higher vitrification temperature or a polymer emulsion with mixed components or a passivation emulsion on the outermost layer.

In addition, it should be noted that the present disclosure is related to a novel functional film, which needs to have the performance of convenient transportation and storage. Therefore, whether the functional film is convenient to wind is also a key point of the present disclosure. According to Comparative Examples 2 and 10, it can be seen that although the adoption of an emulsion with a lower vitrification temperature is conducive to maintaining higher peeling strength, the polymeric film has too high surface viscosity and cannot be wound, thus having no possibility of large-scale production.

For the polymer emulsion with mixed components as the outermost layer, when the ratio of an emulsion with a high vitrification temperature to an emulsion with a low vitrification temperature is not within the scope of the present disclosure, for example, in Comparative Examples 4, 5, 6 and 11, the case that the surface of the functional film is too viscous or too brittle will occur.

For the case that the ratio of components of the passivation emulsion is not within the scope of the present disclosure, in addition to the case that the surface of the functional film is too viscous or too brittle, the peeling strength of the waterproof sheets will also be affected, which is related to the ratio of the second polymerization emulsion to the filler in the passivation emulsion. For example, in Comparative Example 7, the proportion of the filler is higher, and although the problem of winding is solved, the peeling strength is obviously reduced. According to Comparative Example 8, it can be seen that the mesh number of kaolin also has an impact on the peeling strength of the sheets, and although the problem that the surface is too viscous can be solved by adopting the passivation emulsion prepared from the kaolin powder with a low mesh number, the peeling strength is obviously reduced.

In addition, the present disclosure further provides a waterproof system, which includes the aforementioned functional film. With a building surface as a base surface, the waterproof system sequentially includes, from bottom to top, a first asphalt size layer, a first functional film layer, a second asphalt size layer, . . . , an N-th functional film layer and an (N+1) th asphalt size layer, wherein N is a positive integer greater than or equal to 1. The present disclosure further provides a waterproof sheet, which includes the aforementioned functional film.

The examples provided by the present disclosure are elaborated as above. The principles and embodiments of the present disclosure are set forth using specific examples herein, and the description of the above examples is only used to facilitate understanding of core ideas of the present disclosure. It should be pointed out that for those of ordinary skill in the technical field, various improvements and modifications of the present disclosure can also be made without departing from the principles of the present disclosure, and all the improvements and modifications also fall within the scope of protection of the claims of the present disclosure.

What is claimed is:

1. A functional film, characterized in that: the functional film is used for enhancing the bonding strength of a polymeric film and asphalt size and comprises a polymeric film layer and a performance improvement layer coated on at least one surface of the polymeric film layer, the performance improvement layer comprises a viscous layer serving as an inner layer and a passivation layer serving as an outer layer, the viscous layer is formed by evenly coating a first polymer emulsion, a layer number of the viscous layer is greater than or equal to 0, the passivation layer is formed by evenly coating a passivation emulsion, the passivation emulsion is obtained by mixing a second polymer emulsion, a filler and water, a layer number of the passivation layer is greater than or equal to 0, and the layer number of the viscous layer and the layer number of the passivation layer are not 0 simultaneously.

2. The functional film according to claim 1, characterized in that: a vitrification temperature of the first polymer emulsion≤30° C.; preferably, the vitrification temperature of the first polymer emulsion≤20° C.; and more preferably, the vitrification temperature of the first polymer emulsion≤10° C., and when the performance improvement layer is one layer of the viscous layer, the vitrification temperature of the first polymer emulsion is 0-10° C.

3. The functional film according to claim 1, characterized in that: the first polymer emulsion is formed by mixing two or more emulsions with different vitrification temperatures; preferably, the first polymer emulsion is formed by mixing an emulsion with a vitrification temperature≤20° C. and an emulsion with a vitrification temperature≥20° C.; and more preferably, the first polymer emulsion is formed by mixing the emulsion with the vitrification temperature≤10° C. and the emulsion with the vitrification temperature≥10° C.

4. The functional film according to claim 3, characterized in that: n the emulsion with the high vitrification temperature and the emulsion with the low vitrification temperature are mixed at a ratio of 1:(0.5-1.5).

5. The functional film according to claim 1, characterized in that: in the passivation emulsion, a mass ratio of the second polymer emulsion, the filler and the water is 1:(0.5-2):(0.7-2.5); preferably, the mass ratio of the second polymer emulsion, the filler and the water is 1:(1.0-1.5):(1-2); and more preferably, the passivation emulsion further includes a functional auxiliary agent, and a mass ratio of the second polymer emulsion, the filler, the water and a functional auxiliary agent is 1:(0.5-2):(0.7-2.5):(0.02-0.1).

6. The functional film according to claim 5, characterized in that: according to addition amounts calculated by mass fraction, the functional auxiliary agent comprises one or more of 0.03-0.5% of a thicker, 0.1-0.5% of a wetting agent, 0.1-0.5% of a dispersant, 0.01-0.5% of a defoamer, and 0.01-0.1% of a preservative, and the balance of water.

7. The functional film according to claim 1, characterized in that: a mesh number of the filler≥2,000, and the filler comprises one or more of a kaolin powder, a barium sulfate powder, and a titanium dioxide powder.

8. The functional film according to claim 1, characterized in that: the performance improvement layer further comprises a transition layer, the layer number of the viscous layer is greater than or equal to 1, the layer number of the passivation layer is greater than or equal to 1, the transition layer is arranged between the viscous layer and the passivation layer, the transition layer is formed by evenly coating a third polymer emulsion, and the third polymer emulsion is prepared by mixing two or more emulsions with different vitrification temperatures; more preferably, the third polymer emulsion is prepared by mixing an emulsion with a vitrification temperature≤20° C. and an emulsion with a vitrification temperature≥20° C.; and more preferably, the third polymer emulsion is prepared by mixing the emulsion with the vitrification temperature≤20° C. and the emulsion with the vitrification temperature≥20° C. at 1:(0.6-1).

9. The functional film according to claim 1, characterized in that: the first polymer emulsion and the second polymer emulsion are both one or more of an acrylic emulsion, a styrene-butadiene emulsion, and a VAE emulsion, and alternatively, the first polymer emulsion and the second polymer emulsion are both a compound emulsion of a styrene-acrylic copolymer emulsion and a butadiene-styrene-acrylic copolymer emulsion; and
more preferably, the first polymer emulsion and the second polymer emulsion are both the acrylic emulsion.

10. A method for preparing a functional film, used for preparing the functional film according to claim 1, characterized in that: the method comprises the following steps:
unwinding the polymeric film layer, sequentially coating the first polymer emulsion and/or the passivation emulsion on the polymeric film layer to serve as the performance improvement layer, and winding the performance improvement layer for later use after drying;
when the first polymer emulsion or the passivation emulsion is coated, a scrape coating amount of the polymeric film layer per square meter≥20 g/m²; and more preferably, the scrape coating amount of the polymeric film layer per square meter≥30 g/m².

11. An application of a functional film, characterized in that: asphalt size in a flowing state is coated on the functional film according to claim 1.

12. An application of a functional film, characterized in that: asphalt size in a flowing state is coated on the functional film according to claim 2.

13. An application of a functional film, characterized in that: asphalt size in a flowing state is coated on the functional film according to claim 3.

14. A waterproof system, characterized in that: the waterproof system comprises the functional film according to claim 1.

15. The waterproof system according to claim 14, characterized in that: with a building surface as a base surface, the waterproof system sequentially comprises, from bottom to top, a first asphalt size layer, a first functional film layer, a second asphalt size layer, . . . , an N-th functional film layer and an (N+1) th asphalt size layer, wherein N is a positive integer greater than or equal to 1.

16. A waterproof system, characterized in that: the waterproof system comprises the functional film according to claim 2.

17. A waterproof system, characterized in that: the waterproof system comprises the functional film according to claim 3.

18. A waterproof sheet, characterized in that: the waterproof sheet comprises the functional film according to f claim 1.

19. A waterproof sheet, characterized in that: the waterproof sheet comprises the functional film according to f claim 2.

20. A waterproof sheet, characterized in that: the waterproof sheet comprises the functional film according to f claim 3.
